(19) United States
(12) Patent Application Publication
(10) Pub. No.: US 2011/0078632 A1
(43) Pub. Date: Mar. 31, 2011

(54) INSPECTION INFORMATION ADMINISTERING SYSTEM, INSPECTION INFORMATION ADMINISTERING METHOD AND COMPUTER READABLE MEDIUM

(75) Inventors: Hidehito SAKURAI, Tokyo (JP); Shinji KOSUKEGAWA, Kanagawa (JP); Kunimasa SHIMIZU, Tokyo (JP); Takayoshi KIUCHI, Tokyo (JP); Goro MIURA, Tokyo (JP); Koichiro MIYAZAKI, Tokyo (JP); Wataru MATSUI, Tokyo (JP); Yasuhiro ASAI, Tokyo (JP)

(73) Assignee: FUJIFILM CORPORATION, Tokyo (JP)

(21) Appl. No.: 12/894,359

(22) Filed: Sep. 30, 2010

(30) Foreign Application Priority Data
Sep. 30, 2009 (JP) 2009-228671
Aug. 31, 2010 (JP) 2010-195231

(51) Int. Cl. G06F 3/048

(52) U.S. Cl. 715/835

(57) ABSTRACT

An inspection information administering system for recording and managing various kinds of information about an inspection, includes: a selection unit which selects a piece of information to be referred to or edited; and a display unit which displays a reference/edition screen corresponding to the piece of information selected by the selection unit. The selection unit can select a plurality of pieces of information. The display unit displays reference/edition screens corresponding to a plurality of pieces of information in different display regions simultaneously and respectively, when the plurality of pieces of information are selected by the selection unit.

### CROSS-REFERENCE TO RELATED APPLICATIONS

This application is based on and claims priority under 35 USC 119 from Japanese Patent Application Nos. 2009-228671 filed on Sep. 30, 2009; 2010-195231 filed on Aug. 31, 2010; the entire contents of which are incorporated herein by reference.

### BACKGROUND

1. Technical Field

The present invention relates to an inspection information administering system and an inspection information administering method for recording and managing various kinds of information about inspection, such as inspection request information and inspection practice information, and a computer readable medium allowing a computer to execute the same method.

2. Related Art

The inspection information administering system disclosed in Patent Document 1 (JP-A-2002-73615) is a system for managing inspection information in a medical facility. The inspection information administering system records image information obtained by inspection and various kinds of information such as patient's information and inspection request information in association with each other, and acquires and displays desired image information from the various kinds of information. In this system, control is made to allow only necessary information to be displayed/inputted in accordance with a flow of inspection operation. For example, only a selected image which is selected in advance from the image information obtained by inspection is displayed on a report input screen. To refer to any other image than the selected image, an image confirmation button in a submenu is selected to change the screen to an image confirmation screen, where the other image can be referred to.

In the inspection information administering system disclosed in Patent Document 1, control is made to allow only necessary information to be displayed or inputted on the screen in accordance with the flow of the inspection operation. When, for example, there is an insufficient part in the displayed information, it is necessary to switch the screen to a reference/edition screen for the insufficient information. This operation is not efficient because it cannot be performed in parallel at the same time.

### SUMMARY

An illustrative aspect of the invention is to concurrently display information reference/edition screens on different display regions to thereby improve efficiency of inspection work.

[1] According to an aspect of the invention, an inspection information administering system for recording and managing various kinds of information about an inspection, includes: a selection unit which selects a piece of information to be referred to or edited; and a display unit which displays a reference/edition screen corresponding to the piece of information selected by the selection unit. The selection unit can select a plurality of pieces of information. The display unit displays reference/edition screens corresponding to a plurality of pieces of information in different display regions simultaneously and respectively, when the plurality of pieces of information are selected by the selection unit.

[2] According to another aspect of the invention, an inspection information administering method for recording and managing various kinds of information about an inspection, includes: displaying a reference/edition screen corresponding to a selected piece of information on a display unit when the piece of information is selected by a selection unit in order to be referred to or edited by a computer. The displaying step includes displaying reference/edition screens corresponding to a plurality of pieces of information in different display regions of a display unit simultaneously and respectively, when the plurality of pieces of information are selected by the selection unit.

With the configuration of any one of [1] and [2], it is possible to concurrently display information reference/edition screens on different display regions to thereby improve efficiency of inspection work.

### BRIEF DESCRIPTION OF THE DRAWINGS

FIG. 1 is a diagram showing an overall configuration of a hospital system.

FIG. 2 is a diagram showing a schematic configuration of an endoscopic sector system.

FIG. 3 is a diagram showing a schematic configuration of a client PC.

FIG. 4 is a view showing main functions provided by an application program installed in the client PC.

FIG. 5 is a view showing a login screen displayed on a display portion of the client PC.

FIG. 6 is a view showing an order retrieval screen displayed on the display portion of the client PC.

FIG. 7 is a view showing an inspection request information detail screen displayed on the display portion of the client PC.

FIG. 8 is a view showing an interview/pretreatment screen displayed on the display portion of the client PC.

FIG. 9 is a view showing an interview/pretreatment screen displayed on the display portion of the client PC.

FIG. 10 is a view showing an image display screen displayed on the display portion of the client PC.

FIG. 11 is a view showing a report registration screen displayed on the display portion of the client PC.

FIG. 12 is a view showing a pathological inspection request screen displayed on the display portion of the client PC.

FIG. 13 is a view showing a practice report screen displayed on the display portion of the client PC.

FIG. 14 is a view showing a logout screen displayed on the display portion of the client PC.

FIG. 15 is a view showing an example of multi-monitor display.

FIG. 16 is a view showing an example of multi-monitor display.

FIG. 17 is a view showing an example of multi-monitor display.

FIG. 18 is a view showing an example of multi-monitor display.

FIG. 19 is a view showing an example of multi-monitor display.

### DETAILED DESCRIPTION

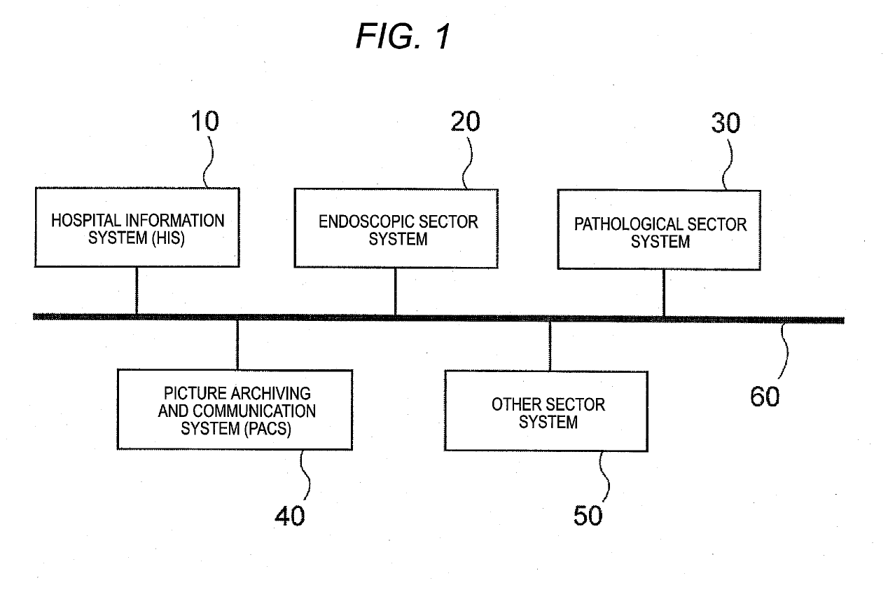

FIG. 1 shows a schematic configuration of a hospital system.

The hospital system shown in FIG. 1 includes a hospital information system (HIS) 10, an endoscopic sector system 20, a pathological sector system 30, a picture archiving and communication system (PACS) 40, and an other sector system 50. These systems 10 to 50 are connected to a hospital LAN 60 so that these systems 10 to 50 can work with one another.

The HIS 10 is a comprehensive system including a medical coding/billing system, a medical practice reservation system, a medical practice information system, etc. The HIS 10 has an electronic medical record database etc. Electronic medical records in which medical practice information of patients has been recorded are stored in the electronic medical record database.

Assume that an inspection request from another medical department is sent to the endoscopic sector. When information about the inspection request (order) (hereinafter referred to as inspection request information) is issued, the information inspection request is transmitted to the endoscopic sector system 20 through the HIS 10.

For example, the inspection request information includes patient's information, order key information (“order number”, “date and time of occurrence”, etc.), request source information (“requesting department name”, “requesting doctor name”, “request date”, etc.), order information (“requested disease name”, “inspection purpose”, “inspection kind”, “inspection item”, “inspection region”, “comment”, etc.), inspection reservation information (“inspection date”, “practice time”, etc.), etc. The patient's information is information about a patient, including “patient ID” as patient-specific information, “patient name”, “birth date”, “age”, “sex”, “inpatient/outpatient distinction”, etc.

The endoscopic sector system 20 is a system for administering the endoscopic sector.

The pathological sector system 30 is a system for administering a pathological sector.

The PACS 40 is a system for electronically storing, retrieving and analyzing each inspection image from a medical image diagnostic device such as an endoscopic inspection device, a CT or an MRI.

The other sector system 50 is a system for administering the other sectors such as a medical coding/billing system.

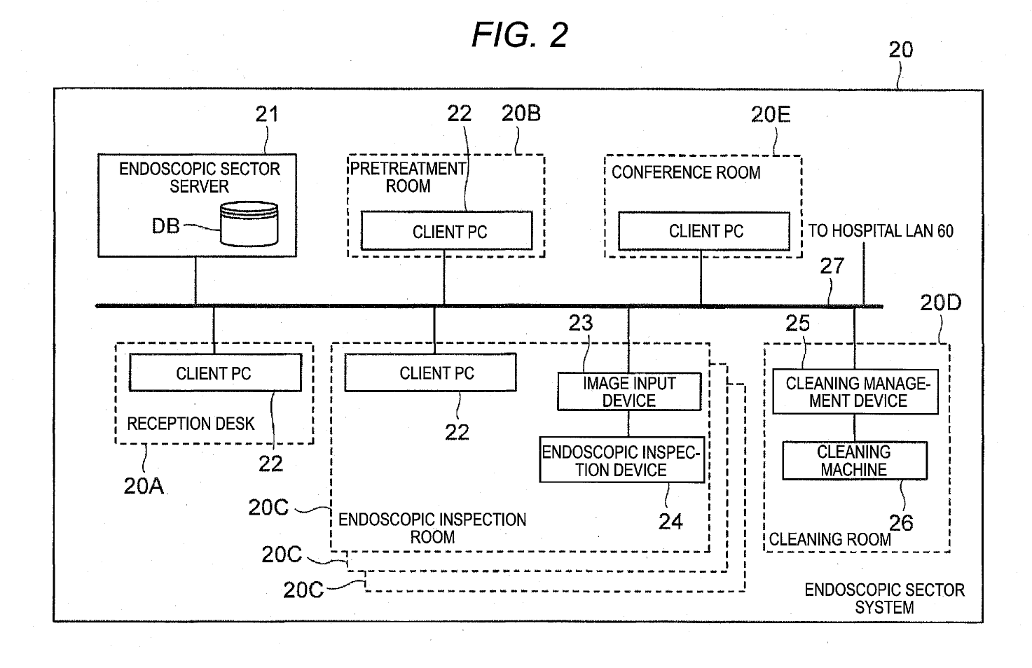

FIG. 2 shows a schematic configuration of the endoscopic sector system in FIG. 1.

The endoscopic sector includes a reception desk 20A, a pretreatment room 20B, endoscopic inspection rooms (hereinafter referred to as inspection rooms) 20C, a cleaning room 20D, and a conference room 20E.

The reception desk 20A is a site for accepting inspections. The pretreatment room 20B is a room for interview and pretreatment before endoscopic inspection. The inspection rooms 20C are rooms for endoscopic inspections. The cleaning room 20D is a room for cleaning endoscopes etc. used for the endoscopic inspections.

The endoscopic sector system 20 shown in FIG. 2 has an endoscopic sector server 21, client PCs 22, image input devices 23, endoscopic inspection devices 24, a cleaning management device 25 and a cleaning machine 26. The endoscopic sector server 21, the client PCs 22, the image input devices 23, and the cleaning management device 25 are connected to an intrasectoral LAN 27. The intrasectoral LAN 27 is connected to the hospital LAN 60.

The endoscopic sector server 21 is a computer for generally controlling the client PCs 22, the image input devices 23, and the cleaning management device 25. A database DB is built in the endoscopic sector server 21. Various kinds of information (inspection request information, inspection result information etc.) are stored in the database DB.

The image input devices 23 and the endoscopic inspection devices 24 are placed in the inspection rooms 20C respectively.

Each image input device 23 is connected to the endoscopic inspection device 24 in the inspection room 20C where the image input device 23 is placed. The image input device 23 is a device by which image information obtained by capturing images with the endoscopic inspection device 24 connected thereto is supplied to the endoscopic sector server 21. The image information supplied by the image input device 23 is stored by the PASC 40 under the control of the endoscopic sector server 21. An endoscopic inspection device integrated with the image input device 23 may be used as the endoscopic inspection device 24.

The cleaning machine 26 and the cleaning management device 25 are placed in the cleaning room 20D. The cleaning machine 26 is a device for cleaning endoscopes etc. used for endoscopic inspections.

The cleaning management device 25 is a computer which is connected to the cleaning machine 26 and by which information of a cleaning history or the like by the cleaning machine 26 is inputted in the endoscopic sector server 21.

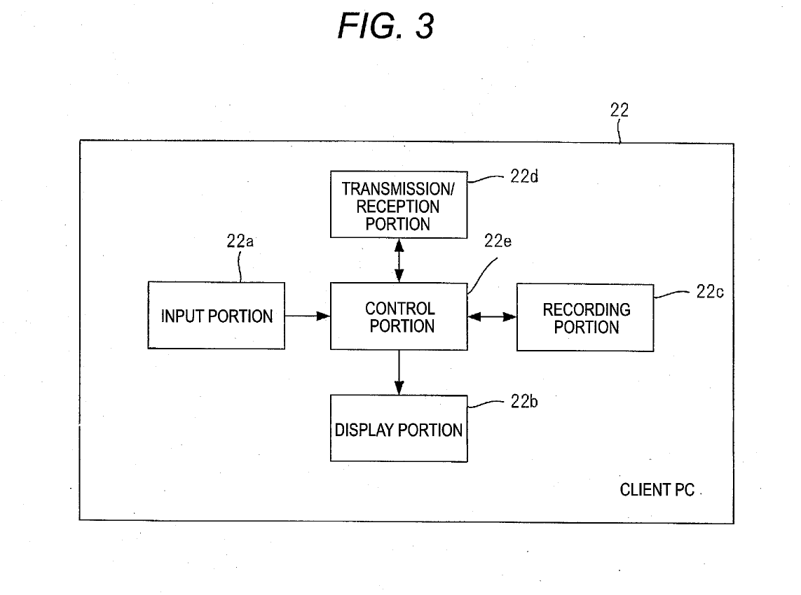

FIG. 3 shows an internal configuration of each client PC in the endoscopic sector system shown in FIG. 2.

As shown in FIG. 3, each client PC 22 includes an input portion 22a, a display portion 22b, a recording portion 22c, a transmission/reception portion 22d and a control portion 22e.

The input portion 22a is an input unit for performing various inputs. The input portion 22a is constituted by input devices such as a keyboard and a touch panel, and pointing devices such as a mouse and a trackball.

The display portion 22b is a display device for performing various displays such as an image and a report. The display portion 22b is constituted by one or more monitors such as LCDs or CRTs.

The recording portion 22c is constituted by a hard disk or the like for recording various data.

The transmission/reception portion 22d is constituted by a transmission/reception interface circuit or the like to execute processing for transmitting/receiving various instructions, various requests and various data through the intrasectoral LAN 27.

The control portion 22e includes a processor such as a CPU (Central Processing Unit), a program memory portion such as an ROM (Read-Only Memory) for storing programs, and a storage portion.

The storage portion in the control portion 22e is constituted by a system memory, a nonvolatile RAM (Random Access Memory) or the like, which forms work areas for executing the programs.

The control portion 22e performs control on the respective portions of the client PC 22 in accordance with the programs, various requests transmitted from the outside through the intrasectoral LAN 27, instruction information inputted from the input portion 22a, etc.

A predetermined application program (hereinafter referred to as program simply) is installed in the client PC. Reference/edition of data recorded in the database DB of the endoscopic sector server 21 (see FIG. 2), registration of data into the database, etc. can be performed by this program.

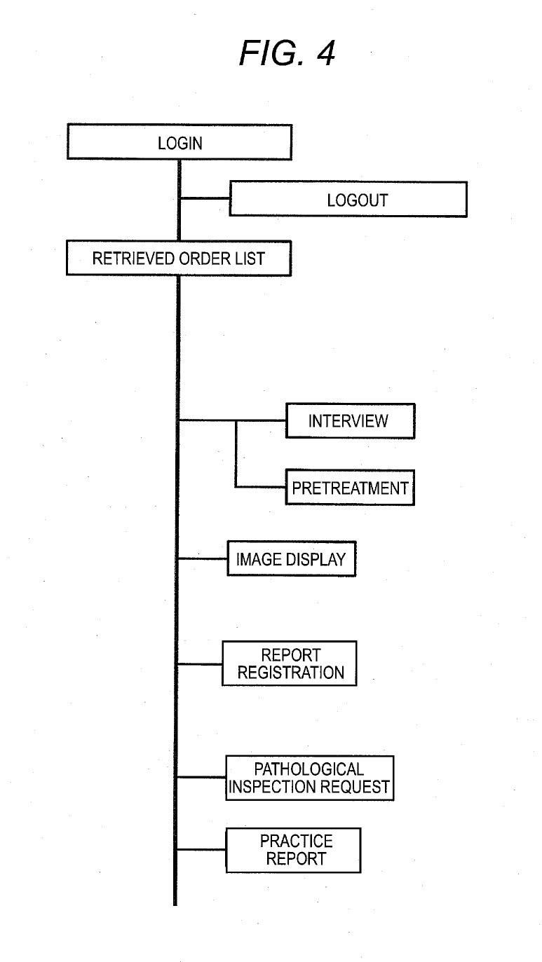

FIG. 4 shows main functions provided by the program installed in the client PC.

As shown in FIG. 4, a login function, a logout function, an order retrieval function, an interview/pretreatment function, an image display function, a report registration function, a pathological inspection request function, and a practice report function are provided by the program. These functions will be described below.

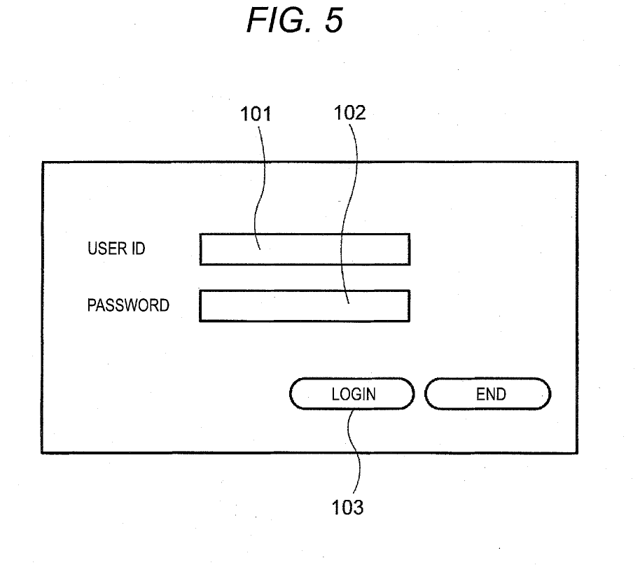

FIG. 5 is an example of a screen to be displayed during execution of the login function.

The login screen shown in FIG. 5 is displayed immediately after the program is activated. A user ID entry field 101 and a password entry field 102 are displayed on the login screen. When a predetermined user ID and a predetermined password are entered into the user ID entry field 101 and the password entry field 102 respectively and a login button 103 is clicked, the endoscopic sector server 21 checks the inputted user ID and password to perform user authentication. When the user authentication is successful in the endoscopic sector server 21, the login is completed.

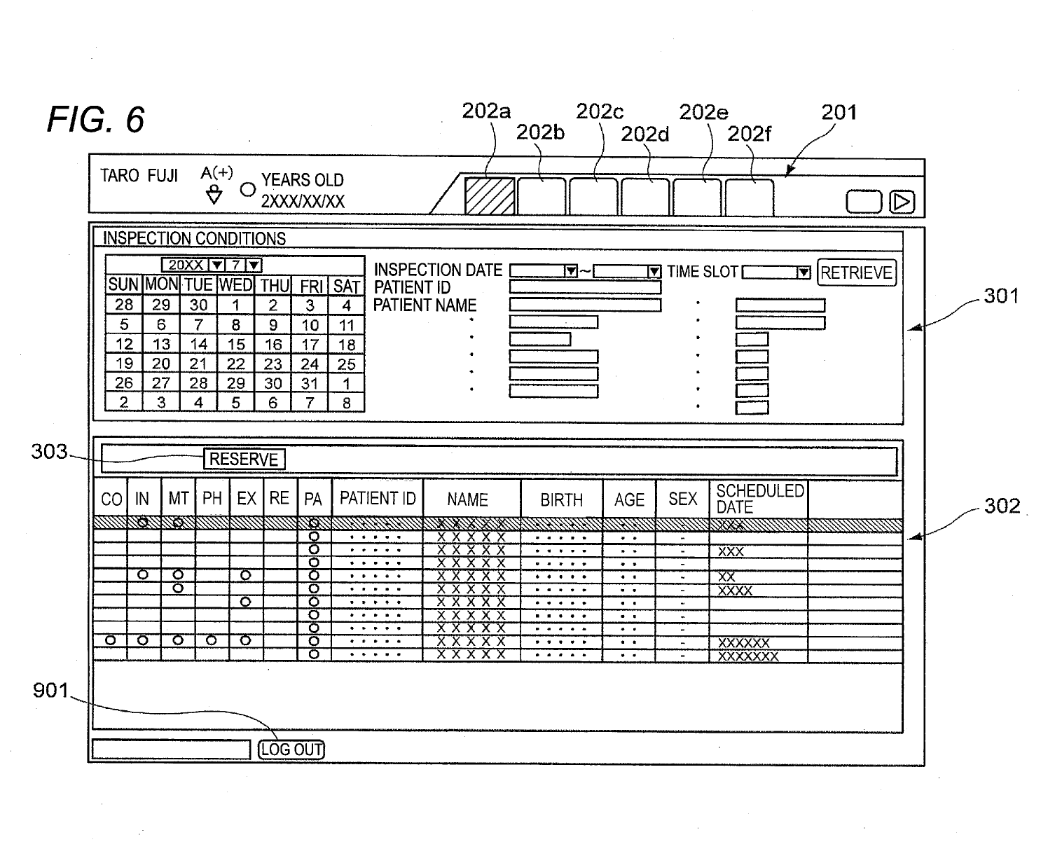

FIG. 6 shows an example of a screen to be displayed during execution of the order retrieval function.

The order retrieval screen shown in FIG. 6 is displayed after the login is completed. The order retrieval screen is roughly constituted by a launcher bar 201 in an upper portion of the screen, a retrieval condition setting region 301 in a center portion of the screen, and a retrieval result display region 302 in a lower portion of the screen.

A retrieval list icon 202a, an interview/pretreatment icon 202b, an image display icon 202c, a report icon 202d, a pathological inspection request icon 202e, and a practice report icon 202f are displayed in the launcher bar 201. The icons 202a to 202f are provided for activating various functions provided by the program. A predetermined function is assigned to each icon. Specifically, the order retrieval function, the interview/pretreatment function, the image display function, the report registration function, the pathological inspection request function, and the practice report function are assigned to the inspection list icon 202a, the interview/pretreatment icon 202b, the image display icon 202c, the report icon 202d, the pathological inspection request icon 202e and the practice report icon 202f, respectively. As soon as each icon is clicked, the screen is replaced by a screen corresponding to the function assigned to the clicked icon. The launcher bar 201 is always displayed in the upper region of any function screen by which the screen is replaced.

A form for inputting various retrieval conditions in order to retrieve inspection request information recorded in the database is displayed in the retrieval condition setting region 301. For example, inspection date, time slot, patient ID, patient name, etc. are set as the retrieval conditions.

Of inspection request information recorded in the database DB, pieces corresponding to the retrieval conditions set in the retrieval condition setting region 301 are listed and displayed in the retrieval result display region 302. When one piece is selected from the pieces of inspection request information displayed in the retrieval result display region 302, information about various operations (including acceptance, interview/pretreatment, image display, report registration, pathological inspection request and practice report) subordinate to the inspection in the selected piece of inspection request information can be referred to, edited and registered subsequently.

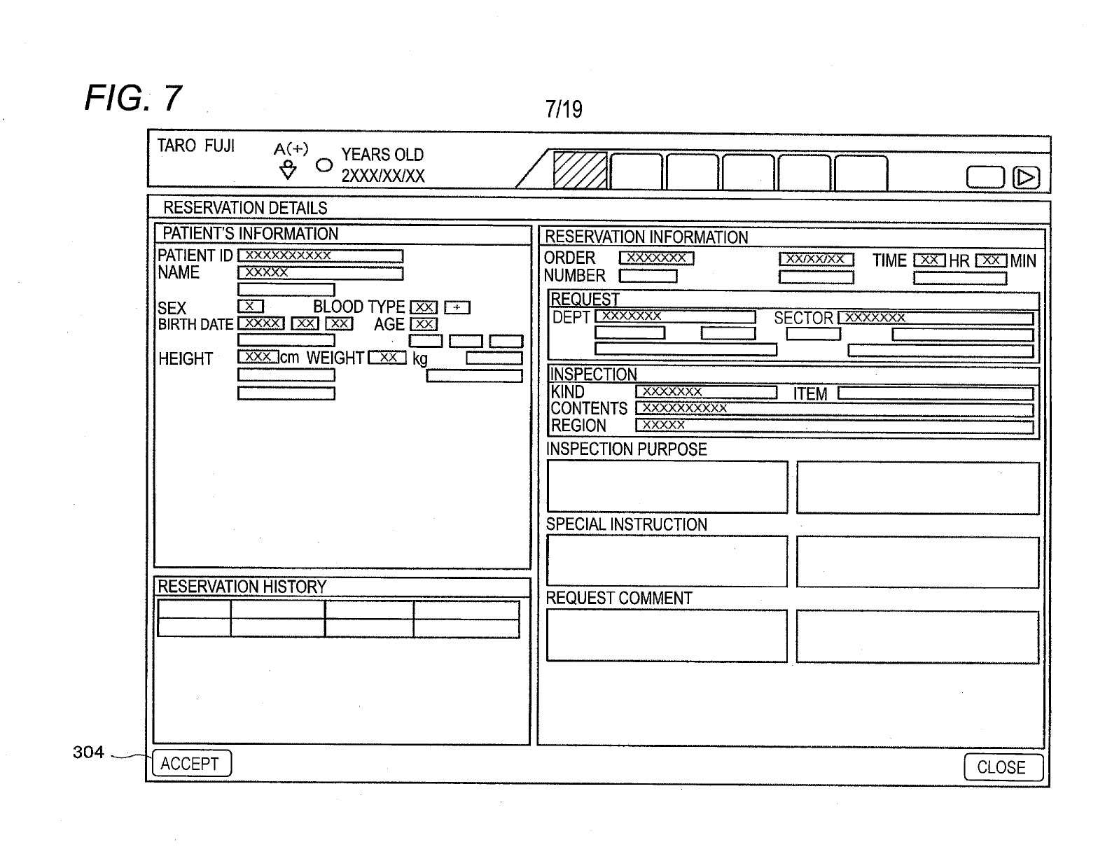

When, for example, a patient visits the hospital for the sake of inspection, inspection request information is retrieved in the reception desk 20A (see FIG. 2) based on patient's information such as the name of the patient, the date, etc., and one piece of inspection request information is selected from pieces of inspection request information listed an displayed as pieces corresponding to retrieval conditions. When a reserve button 303 is clicked in this state, the details of the selected piece of inspection request information is displayed as shown in FIG. 7. The details of the inspection request information are checked with the patient's information, the date, etc. When it is confirmed that the selected piece of inspection request information is a desired piece of inspection request information, an accept button 304 is clicked for acceptance. The information of acceptance is supplied to the endoscopic sector server 21 through the client PC 22, and registered into the database DB in association with the selected piece of inspection request information.

When any one of the interview/pretreatment icon 202b, the image display icon 202c, the report icon 202d, the pathological inspection request icon 202e and the practice report icon 20f in the launcher bar 201 is clicked in the state in which one piece of inspection request information has been selected in the retrieval result display region 302, the screen is replaced by a function screen corresponding to the clicked icon. On the function screen by which the screen is replaced, information about various operations subordinate to the inspection in the selected piece of inspection request information can be referred to, edited and registered.

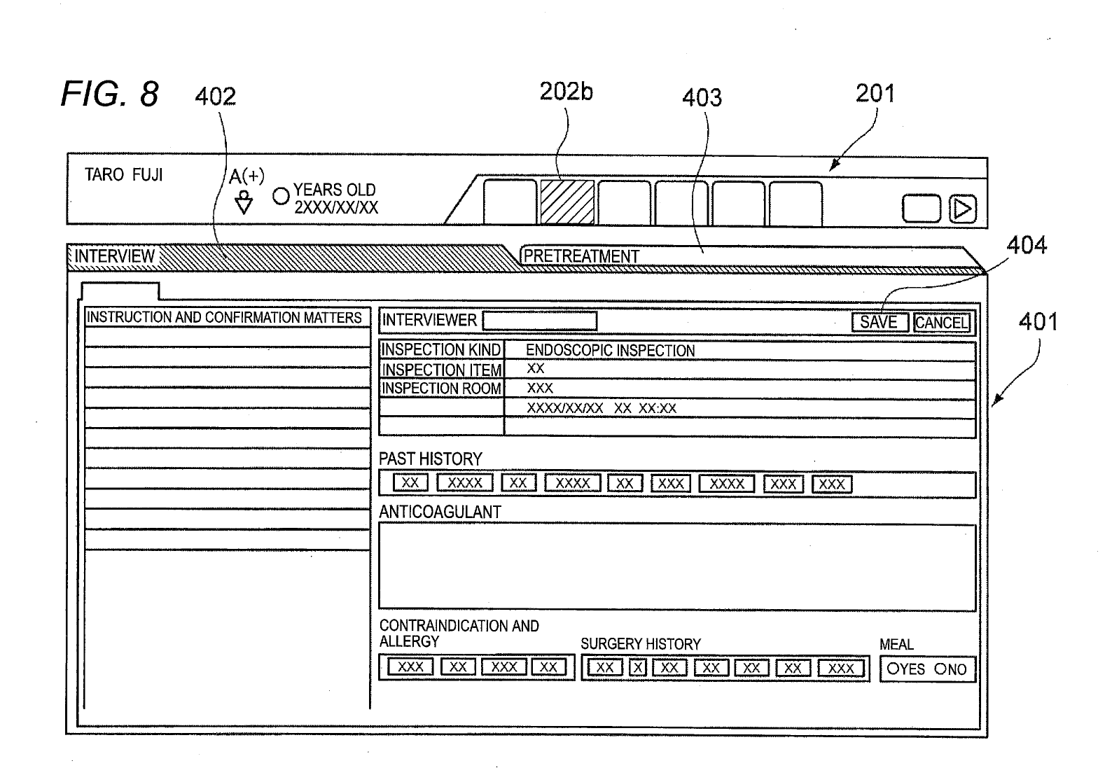

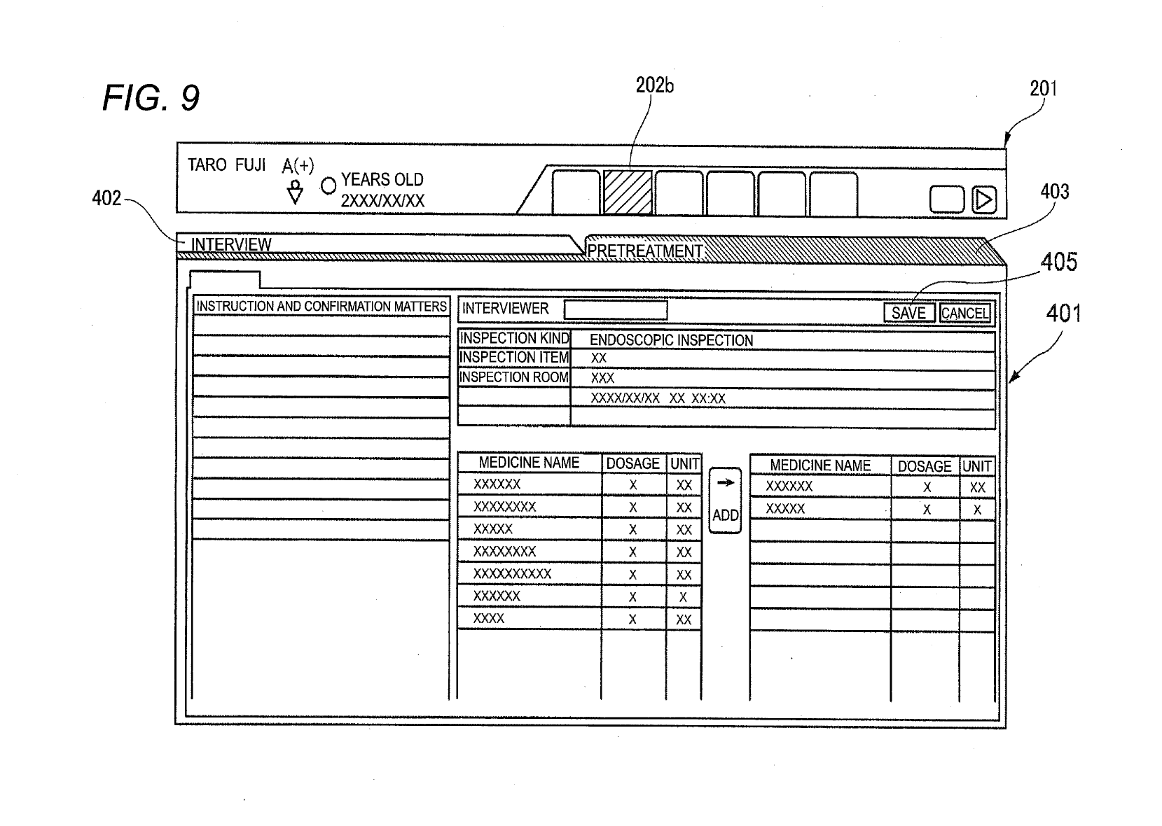

FIGS. 8 and 9 are examples of a screen to be displayed during execution of the interview/pretreatment function.

When the interview/pretreatment icon 202b in the launcher bar 201 is clicked, the interview/pretreatment screen shown in FIG. 8 or 9 is displayed. This interview/pretreatment screen is roughly constituted by the launcher bar 201 and an interview/pretreatment information input region 401.

A form for inputting interview information obtained by interview, such as a past history of a patient, and a form for inputting pretreatment information such as medicines etc. given to the patient as pretreatment are alternatively displayed in the input region 401. The displayed form can be switched by selection of a tub 402, 403 provided in the upper portion of the input region 401.

FIG. 8 shows a state where the interview form is displayed in the input region 401. When a save button 404 is clicked, interview information inputted in each field of the form is registered in the database DB in association with the selected piece of inspection request information. When interview information has been recorded in the database DB in association with the selected piece of inspection request information, the interview information is displayed in each field of the form.

FIG. 9 shows a state where the pretreatment form is displayed in the input region 401. When a save button 405 is clicked, pretreatment information inputted in each field of the form is registered in the database DB in association with the selected piece of inspection request information. When pretreatment information has been recorded in the database DB in association with the selected piece of inspection request information, the pretreatment information is displayed in each field of the form.

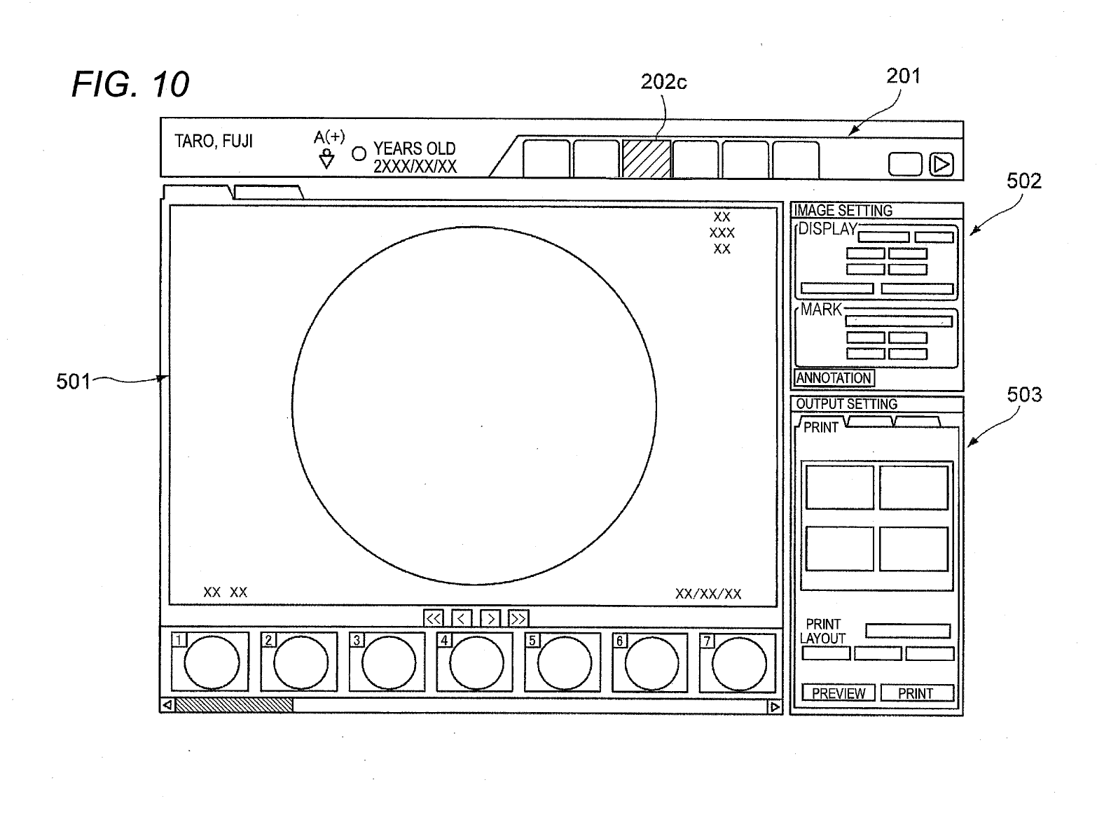

FIG. 10 shows an example of a screen to be display during execution of the image display function.

When the image display icon 202c in the launcher bar 201 is clicked, the image display screen shown in FIG. 10 is displayed. This image display screen is roughly constituted by the launcher bar 201, an image display region 501, an image setting region 502, and an output setting region 503.

Of image information captured by the endoscopic inspection devices 24 (see FIG. 2) and saved in the PACS 40 (see FIG. 1) in association with respective pieces of inspection request information, pieces associated with the selected piece of inspection request information are displayed as images in the image display region 501. In the display example of FIG. 10, a plurality of pieces of image information are listed and displayed as thumbnail images in the image display region 501, and a selected piece of those pieces of image information is displayed as an image larger in size than any other thumbnail image.

Buttons for setting a method for displaying images in the image display region 501 are displayed in the image setting region 502. An example of the display method may include a method in which a plurality of selected images are arranged side by side and displayed in a reduced manner as compared with the example of FIG. 10. In addition, buttons for performing marking and annotation on selected images are displayed in the image setting region 502. Marking is to add a predetermined mark to an image so as to indicate that the image corresponds to a specific case. Annotation is to draw a desired comment, a desired graphic, etc. Marks added by marking, comments drawn by annotation, etc. are stored in the PACS 40 together with image information of images where the marks and the comments are added and drawn.

Buttons etc. for setting output processing for selected images, such as printing, are displayed in the output setting region 503.

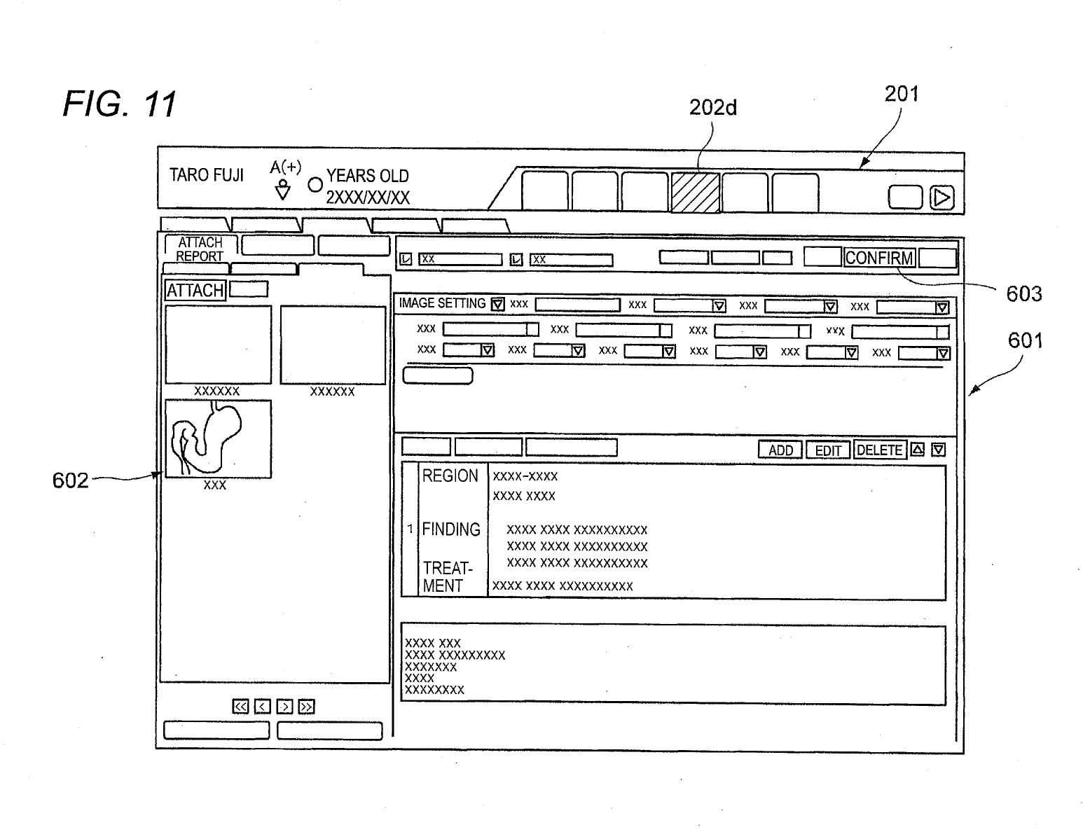

FIG. 11 shows an example of a screen to be displayed during execution of the report registration function.

When the report icon 202d in the launcher bar 201 is clicked, the report registration screen shown in FIG. 11 is displayed. This report registration screen is roughly constituted by the launcher bar 201, a report information input region 601 and an attached information setting region 602.

A form for inputting report information such as findings, diagnoses, etc. in inspection is displayed in the report information input region 601. Report information inputted in each field of the form is registered in the database DB in association with the selected piece of inspection request information when a decide button 603 is clicked.

Information to be attached to the report is displayed in the attached information setting region 602. An example of the information to be attached includes image information etc. captured by the endoscopic inspection device 24. The image information is stored in the PACS 40 in association with the selected piece of inspection request information. Pieces of image information which are selected in advance in the image display screen (see FIG. 10) are attached.

When report information has been recorded in the database DB in association with the selected piece of inspection request information, the report information is displayed in each field of the form in the report information input region 601, and information such as image information attached to the report information is displayed in the attached information setting region 602.

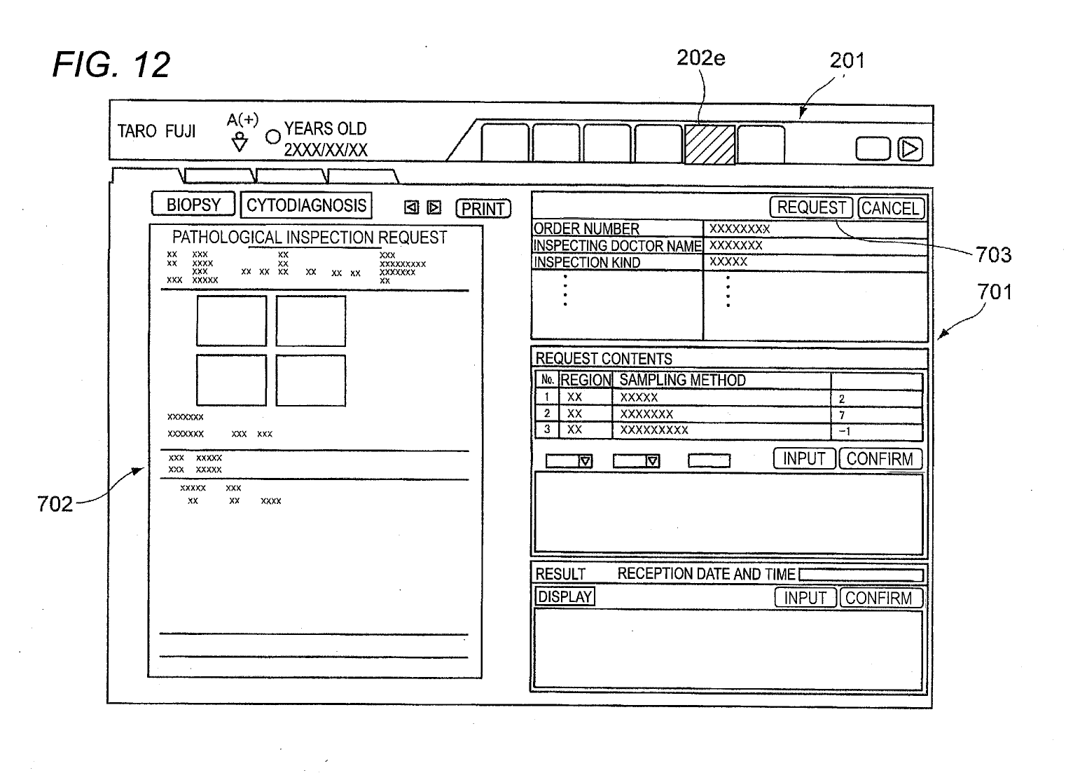

FIG. 12 shows an example of a screen to be displayed during execution of the pathological inspection request function.

When the pathological inspection request icon 202e in the launcher bar 201 is clicked, the pathological inspection request screen shown in FIG. 12 is displayed. This pathological inspection request screen is roughly constituted by the launcher bar 201, a pathological inspection request information input region 701 and a preview region 702.

A form for inputting pathological inspection request information is displayed in the pathological inspection request information input region 701. When a pathological inspection request button 703 is clicked, pathological inspection request information inputted in each field of the form is registered in the database DB in association with the selected piece of inspection request information, and transmitted to the pathological sector system 30 (see FIG. 1) through the hospital LAN 60 (see FIG. 1). When pathological inspection request information has been recorded in the database DB in association with the selected piece of inspection request information, the pathological inspection request information is displayed in each field of the form.

A preview of a pathological inspection request document created based on the pathological inspection request information inputted in the form of the pathological inspection request information input region 701 is displayed in the preview region 702.

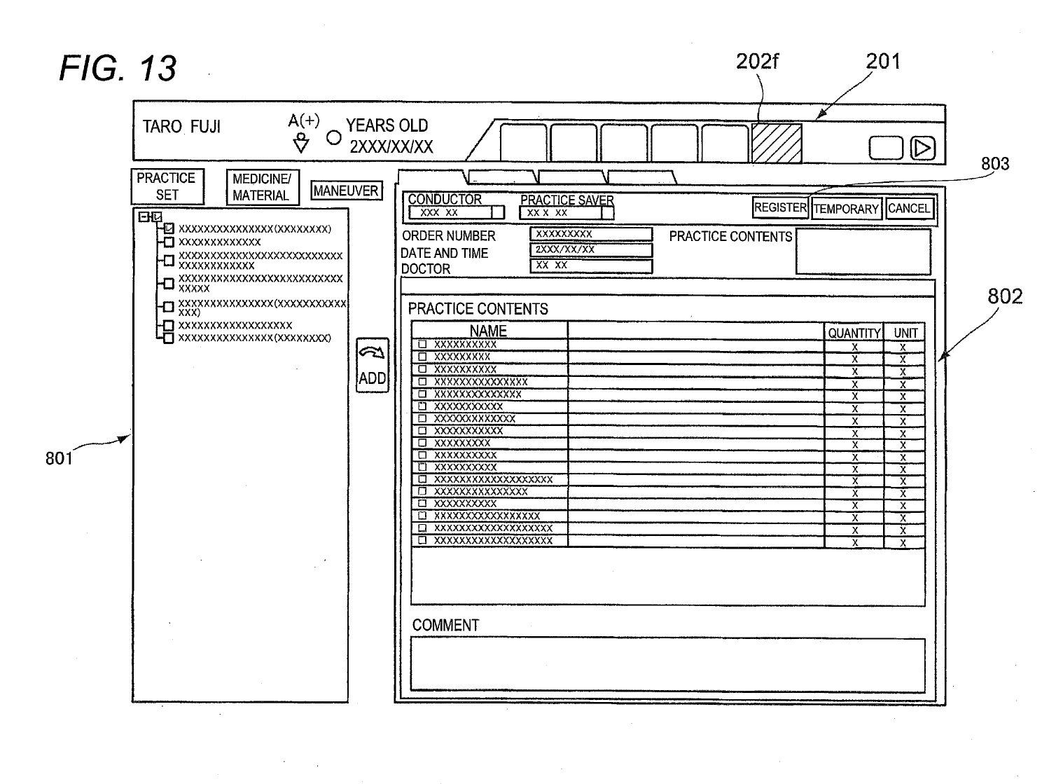

FIG. 13 shows an example of a screen to be displayed during execution of the practice report function.

When the practice report icon 202f in the launcher bar 201 is clicked, the practice report screen shown in FIG. 13 is displayed. This practice report screen is roughly constituted by the launcher bar 201, a selection region 801 for selecting maneuvers, medicines and materials, and a practice information input region 802.

Maneuvers, medicines, materials such as tools, etc. for inspection are listed and displayed in the selection region 801. Of those, maneuvers used actually in inspection, medicines and materials used for pretreatment and inspection are selected. Medicines and materials may be narrowed and displayed in response to the selected maneuvers.

The maneuvers, medicines and materials selected in the selection region 801 are displayed in the practice information input region 802. when a register button 803 is clicked, the practice information displayed in the practice information input region 802 is registered in the database DB in association with the selected piece of inspection request information and the practice information is transmitted to the medical coding/billing system included in the other sector system 50 (FIG. 1) through the hospital LAN 60. The medical coding/billing system carries out billing based on the transmitted practice information. When practice information has been registered in the database DB in association with the selected piece of inspection request information, the practice information is displayed in the practice information input region 802.

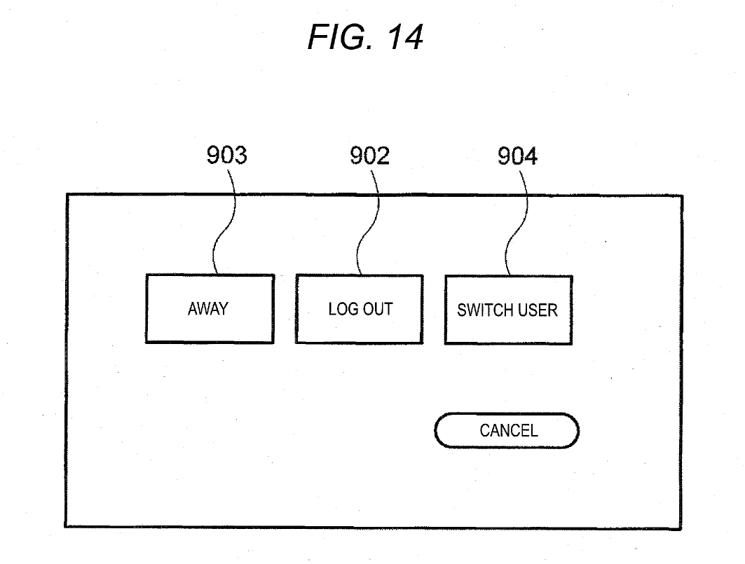

FIG. 14 shows an example of a screen to be displayed during execution of the logout function.

The logout screen shown in FIG. 14 is displayed when a logout button 901 displayed in the lower area of the aforementioned order retrieval screen (see FIG. 6) is clicked on the order retrieval screen. On the logout screen, an away button 903 and a user switching button 904 are displayed as well as a logout button 902. When the away button 903 is clicked, the login screen shown in FIG. 5 is displayed on the whole of the screen to hide information which has been displayed on the screen till then and to prevent others from operating thereon. When the user switching button 904 is clicked, a login user can be switched without returning to the login screen shown in FIG. 5.

In addition to the icons 202a to 202f for displaying the screens for referring to and editing various kinds of information, i.e. inspection request information which has been recorded in the database DB, interview/pretreatment information, image information, report information, pathological inspection request information and practice information which have been recorded in association with the inspection request information, a button 203 for setting multi-monitor display is displayed in the launcher bar 201 which is always displayed on each of the function screens.

The multi-monitor display can be used in various situations, for example, for editing a piece of report information in the report registration screen while referring to a piece of image information in the image display screen, for editing a piece of report information in the report registration screen while referring to a piece of interview information in the interview/pretreatment screen, for editing a piece of practice information in the practice report screen while referring to a piece of report information in the report registration screen, etc. The multi-monitor display will be described below along an example where a piece of report information is edited in the report registration screen while a piece of image information is referred to in the image display screen.

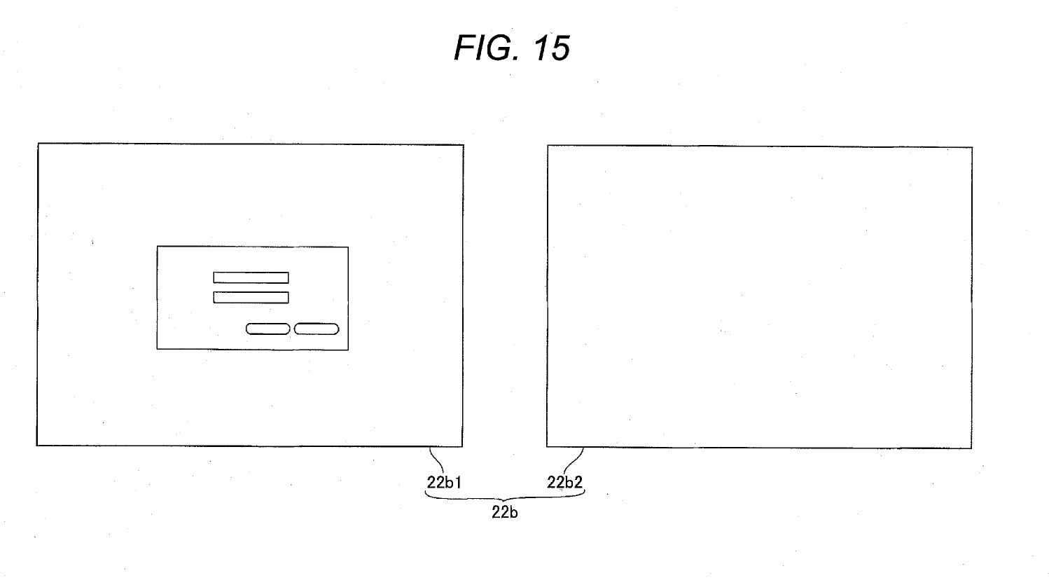

FIGS. 15 to 19 show examples of the multi-monitor display.

As shown in FIG. 15, the display portion 22b of the client PC 22 has two monitors, i.e. a first monitor 22b1 (main monitor) and a second monitor 22b2 (sub monitor). When a program is activated in the client PC 22, the login screen is displayed on the first monitor 22b1.

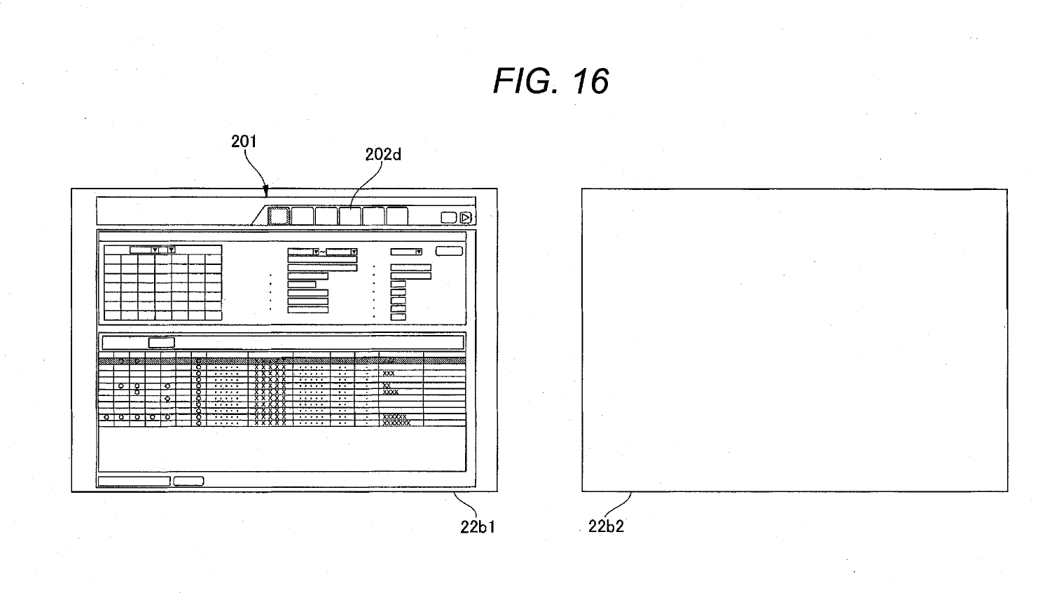

As shown in FIG. 16, the aforementioned order retrieval screen is displayed on the first monitor 22b1 after login. A launcher bar 201 is displayed in an upper region of the order retrieval screen. To refer to and edit a piece of report information, a report icon 202d in the launcher bar 201 is clicked in the state in which a desired piece of inspection request information has been selected in the order retrieval screen of the first monitor 22b1. In response to the clicking of the report icon 202d, the report registration screen is displayed on the first monitor 22b1.

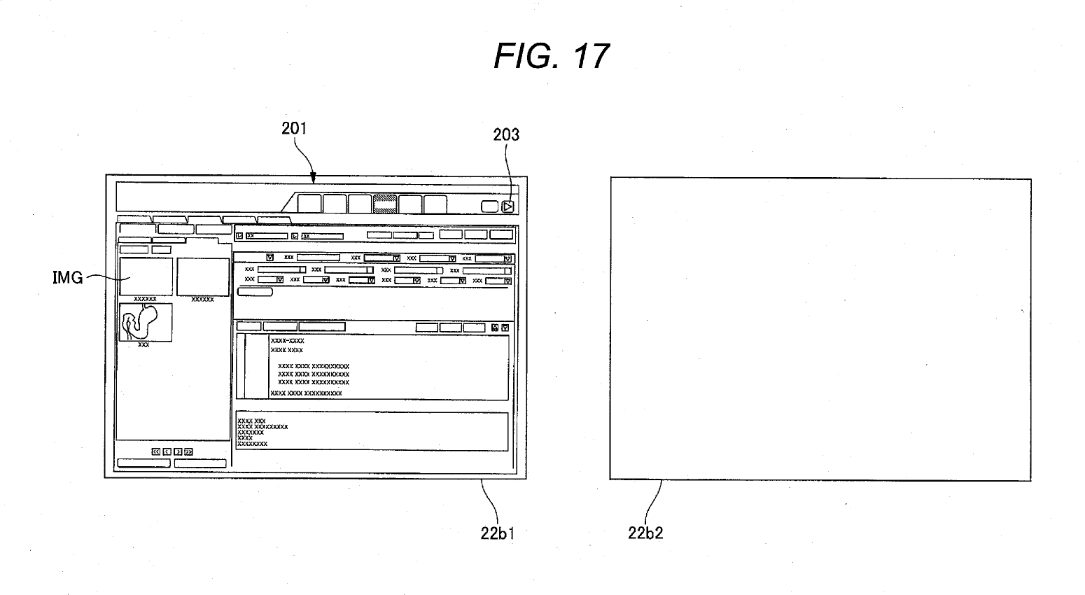

As shown in FIG. 17, a key image IMG which has been selected in advance from a plurality of images stored in the PACS 40 (see FIG. 1) in association with the selected piece of inspection request information is displayed in the report registration screen of the first monitor 22b1. When, for example, it is necessary to refer to any image other than the selected image here, the other image can be referred to in the image display screen. To refer to the other image, a shift button 203 of the launcher bar 201 to the second monitor 22b2 is clicked. In response to the clicking of the shift button 203, a launcher bar is displayed also on the second monitor 22b2.

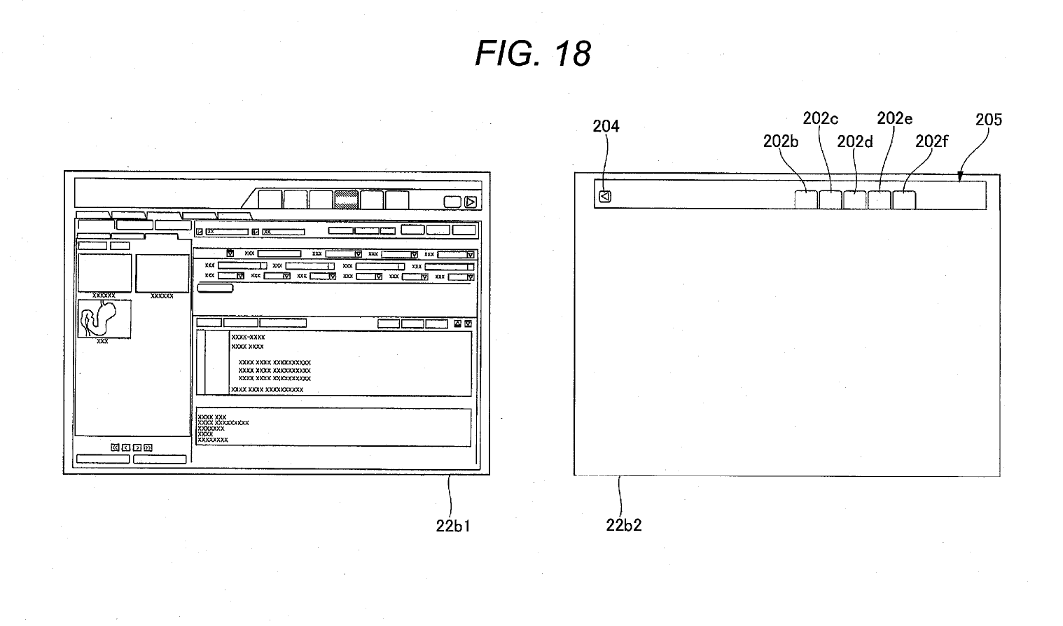

As shown in FIG. 18, an interview/pretreatment icon 202b, an image display icon 202c, a report registration icon 202d, a pathological inspection request icon 202e, a practice report icon 202f and a shift button 204 to the first monitor 22b1 are displayed in a launcher bar 205 of the second monitor 22b2. The launcher bar 205 is also always displayed on the second monitor 22b2. After this, any input made by the input portion 22a of the client PC 22 can be reflected on the display screen of the second monitor 22b2. When the image display icon 202c in the launcher bar 205 is then clicked, an image display screen is displayed on the second monitor 22b2.

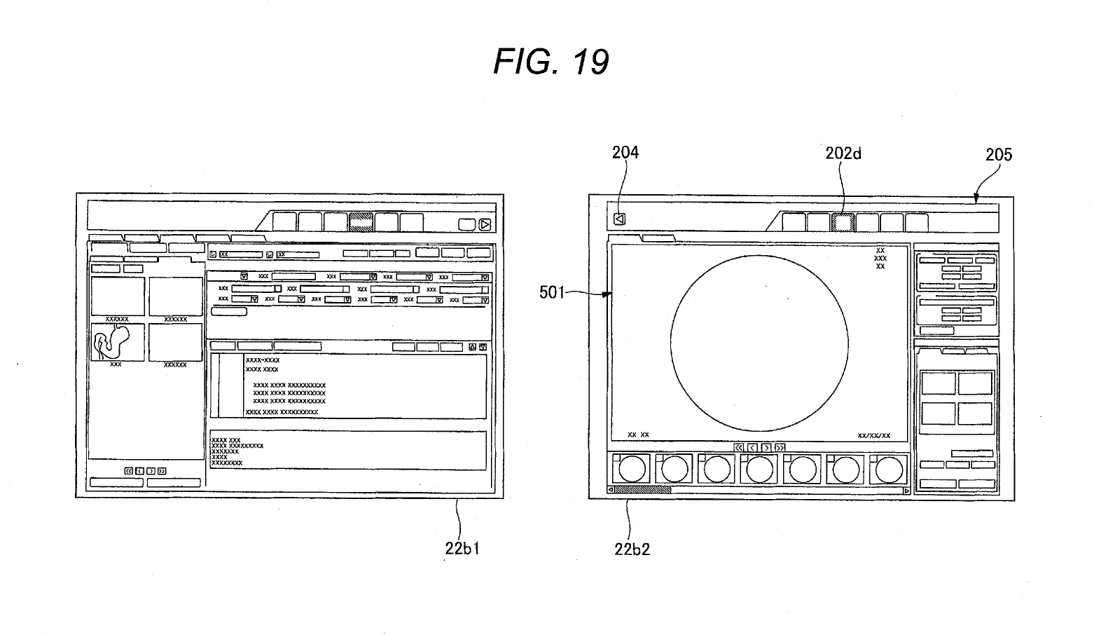

As shown in FIG. 19, a plurality of images stored in the PACS 40 in association with the selected piece of inspection request information are displayed on the image display screen of the second monitor 22b2. A desired image is selected on the image display screen of the second monitor screen 22b2 and displayed in an image display region 501.

After the image has been selected, the shift button 204 of the launcher bar 205 to the first monitor 22b1 is clicked. After this, any input made by the input portion 22a of the client PC 22 can be reflected on the display screen of the first monitor 22b1. In the aforementioned manner, the desired image is displayed on the second monitor 22b2 and the piece of report information on the first monitor 22b1 can be edited with reference to the desired image.

Incidentally, any input on the reference/edition screen of the second monitor 22b2 may be registered into the database DB. The piece of information registered here is reflected on the reference/edition screen of the first monitor 22b1. For example, in the aforementioned example, a piece of information about addition or change of a key image on the image display screen of the second monitor 22b2 may be registered in the database DB. When a key image is added or changed in the image display screen of the second monitor 22b2 and registered in the database DB, the key image displayed on the report registration screen of the first monitor 22b1 is also added or changed in sync with the registration of the key image.

This further improves efficiency of the inspection work when concurrently displaying the information reference/edition screens on different display regions.

However, if a combination of information displayed in the reference/edition screen of the first monitor 22b1 (main monitor) and information displayed in the reference/edition screen of the second monitor 22b2 (sub monitor) corresponds to a specific combination, edit of the information displayed in the reference/edition screen of the second monitor 22b2 may be prohibited.

a combination of pieces of information about practice report and interview/pretreatment, and a combination of pieces of information about pathological inspection request and the report registration each corresponds to the specific combination.

Specifically, the practice information contains the information about medicines used for the pretreatment. Editing the information about the medicines for the pretreatment in the interview/pretreatment screen involves editing the practice information. Also, the pathological inspection request information contains the inspection content described in the report information. Editing the inspection content of the report information in the report registration screen involves editing the pathological inspection request information. However, the practice information is transmitted to the medical coding/billing system, and the pathological inspection request information is transmitted to the pathological sector system 30, respectively. It is not preferable to allow easily adding/editing these pieces of information in the respective screens.

So, the recording portion 22c of the client PC 22 stores a definition file which defines the specific combinations (prohibition combinations) for prohibiting edit of the information displayed in the reference/edition screen of the second monitor 22b2. On the basis of the definition file, the control portion 22e of the client PC 22 exclusively controls reference/edition of the information displayed in the reference/edition screen of the second monitor 22b2 with respect to reference/edition of the information displayed in the reference/edition screen of the first monitor 22b1. If the combination of the information displayed in the reference/edition screen of the first monitor 22b1 and the information displayed in the reference/edition screen of the second monitor 22b2 corresponds to the specific combination (prohibition combination) defined in the definition file, the control portion 22e prohibits all inputs to the regions excepting a region of the launcher bar 205 in the reference/edition screen of the second monitor 22b2.

Hereinafter, exemplifying the combination of the practice report and the interview/pretreatment explains the exclusive control.

Firstly, when the shift button 203 of the launcher bar 201 is clicked in a state that the practice report screen is being displayed on the first monitor 22b1 (See, FIG. 13), the launcher bar 205 is displayed on the second monitor 22b2. Next, when the interview/pretreatment icon 202b of the launcher bar 205 is clicked, the interview/pretreatment screen is displayed on the second monitor 22b2 (See, FIG. 9). The control portion 22e of the client PC determines whether or not a combination of the interview/pretreatment and the practice report corresponds to the specific combination (prohibition combination) defined in the definition file stored in the recording portion 22c. Since the combination of the interview/pretreatment and the practice report corresponds to the specific combination, the control portion 22e does not accept inputs from the input unit 22a to the input region 401 of the interview/pretreatment screen, thereby prohibiting edit of the information displayed in the second monitor 22b2.

When displaying the reference/edition screen on the second monitor 22b2 in a state that the reference/edition screen is being displayed on the first monitor 22b1 and the combination of these reference/edition screens corresponds to the specific combination, displaying the reference/edition screen to be displayed on the second monitor 22b2 may be prohibited. For example, even when the interview/pretreatment icon 202b of the launcher bar 205 of the second monitor 22b2 is clicked in a state that the practice report screen is being displayed on the first monitor 22b1, the control portion 22e controls so that the interview/pretreatment screen would not be displayed. A window having a message that displaying the interview/pretreatment screen is prohibited may be shown on the second monitor 22b2.

Although the example in which a plurality of information reference/edition screens are displayed simultaneously by the multi-monitor display has been described above, a plurality of windows may be opened in a single monitor so that one reference/edition screen can be displayed for each of the windows. Whenever each icon of the launcher bar is selected, a window is opened and a reference/edition screen corresponding to the selected icon is displayed in the window. When the position and size of each of the windows are changed suitably, the windows can be displayed in different display regions simultaneously and respectively.

As described above, it is disclosed that a inspection information administering system for recording and managing various kinds of information about an inspection, includes: a selection unit which selects a piece of information to be referred to or edited; and a display unit which displays a reference/edition screen corresponding to the piece of information selected by the selection unit. The selection unit can select a plurality of pieces of information. The display unit displays reference/edition screens corresponding to a plurality of pieces of information in different display regions simultaneously and respectively, when the plurality of pieces of information are selected by the selection unit.

With this configuration, reference/edition screens for a plurality of pieces of information can be displayed in different display regions simultaneously and respectively so that efficiency of inspection work can be improved.

In the disclosed inspection information administering system, the display unit may have a plurality of monitors so as to display reference/edition screens corresponding to a plurality of pieces of information in the different monitors respectively when the plurality of pieces of information are selected by the selection unit.

With this configuration, reference/edition screens for a plurality of pieces of information can be displayed on different display regions simultaneously and respectively.

In the disclosed inspection information administering system, the display unit can display a plurality of windows on a single monitor so as to display reference/edition screens corresponding to a plurality of pieces of information in different ones of the windows respectively when the plurality of pieces of information are selected by the selection unit.

With this configuration, reference/edition screens for a plurality of pieces of information can be displayed in different display regions simultaneously and respectively.

In the disclosed inspection information administering system, the selection unit may be a launcher which can be always displayed on the display unit.

With this configuration, a necessary information reference/edition screen can be activated easily.

In the inspection information administering system, the inspection information administering system may further includes: a control unit that, when the plurality of pieces of information are selected by the selection unit, defines a piece of main information which is firstly selected from the plurality of pieces of information, and defines pieces of sub information each of which is selected subsequently to the piece of main information. The control unit allows/prohibits edit of each piece of sub information on the basis of a combination of the piece of main information and the piece of sub information.

With this configuration, the information management can be improved with the efficiency of inspection work being improved.

In the inspection information administering system, the inspection information administering system may further include: a recording unit that stores a definition file which defines prohibition combinations for prohibiting the edit of the pieces of sub information, from the combinations of the piece of main information and the respective pieces of sub information. The control unit allows/prohibits the edit of each piece of sub information with referring the definition file.

With this configuration, the prohibition combinations for prohibiting the edit of the pieces of sub information from the combinations of the piece of main information and the respective pieces of sub information can be uniformly managed.

Also, it is disclosed that an inspection information administering method for recording and managing various kinds of information about an inspection, includes: displaying a reference/edition screen corresponding to a selected piece of information on a display unit when the piece of information is selected by a selection unit in order to be referred to or edited by a computer. The displaying step includes displaying reference/edition screens corresponding to a plurality of pieces of information in different display regions of a display unit simultaneously and respectively, when the plurality of pieces of information are selected by the selection unit.

In the disclosed inspection information administering method, the display unit may have a plurality of monitors. The displaying step includes displaying reference/edition screens corresponding to a plurality of pieces of information on the different monitors respectively, when the plurality of pieces of information are selected by the selection unit.

In the disclosed inspection information administering method, the display unit can display a plurality of windows on a single monitor. The displaying step includes displaying reference/edition screens corresponding to a plurality of pieces of information in different ones of the windows respectively when the plurality of pieces of information are selected by the selection unit.

In the inspection information administering method, the selection unit may be a launcher which can be always displayed on the display unit.

In the inspection information administering method, the inspection information administering method may further include: when the plurality of pieces of information are selected by the selection unit, defining a piece of main information which is firstly selected from the plurality of pieces of information, and defining pieces of sub information each of which is selected subsequently to the piece of main information; and allowing/prohibiting edit of each piece of sub information on the basis of a combination of the piece of main information and the piece of sub information.

In the inspection information administering method, the inspection information administering method may further include: storing a definition file which defines prohibition combinations for prohibiting the edit of the pieces of sub information, from the combinations of the piece of main information and the respective pieces of sub information. The allowing/prohibiting step includes allowing/prohibiting the edit of each piece of sub information with referring the definition file.

Also, it is disclosed that a computer readable medium storing a program causing a computer to execute a process for the disclosed inspection information administering method.

What is claimed is:

1. An inspection information administering system for recording and managing various kinds of information about an inspection, comprising:
a selection unit which selects a piece of information to be referred to or edited; and
a display unit which displays a reference/edition screen corresponding to the piece of information selected by the selection unit; wherein:
the selection unit can select a plurality of pieces of information; and
the display unit displays reference/edition screens corresponding to a plurality of pieces of information in different display regions simultaneously and respectively, when the plurality of pieces of information are selected by the selection unit.

2. The inspection information administering system according to claim 1, wherein:
the display unit has a plurality of monitors so as to display reference/edition screens corresponding to a plurality of pieces of information in the different monitors respectively when the plurality of pieces of information are selected by the selection unit.

3. The inspection information administering system according to claim 1, wherein:
the display unit can display a plurality of windows on a single monitor so as to display reference/edition screens corresponding to a plurality of pieces of information in different ones of the windows respectively when the plurality of pieces of information are selected by the selection unit.

4. The inspection information administering system according to claim 1, wherein:
the selection unit is a launcher which can be always displayed on the display unit.

5. The inspection information administering system according to claim 1, further comprising:
a control unit that, when the plurality of pieces of information are selected by the selection unit, defines a piece of main information which is firstly selected from the plurality of pieces of information, and defines pieces of sub information each of which is selected subsequently to the piece of main information, wherein:
a control unit allows/prohibits edit of each piece of sub information on the basis of a combination of the piece of main information and the piece of sub information.

6. The inspection information administering system according to claim 5, further comprising:
a recording unit that stores a definition file which defines prohibition combinations for prohibiting the edit of the pieces of sub information, from the combinations of the piece of main information and the respective pieces of sub information, wherein:
the control unit allows/prohibits the edit of each piece of sub information with referring the definition file.

7. An inspection information administering method for recording and managing various kinds of information about an inspection, comprising:
displaying a reference/edition screen corresponding to a selected piece of information on a display unit when the piece of information is selected by a selection unit in order to be referred to or edited by a computer; wherein:
the displaying step includes displaying reference/edition screens corresponding to a plurality of pieces of information in different display regions of a display unit simultaneously and respectively, when the plurality of pieces of information are selected by the selection unit.

8. The inspection information administering method according to claim 7, wherein:
the display unit has a plurality of monitors; and
the displaying step includes displaying reference/edition screens corresponding to a plurality of pieces of information on the different monitors respectively, when the plurality of pieces of information are selected by the selection unit.

9. The inspection information administering method according to claim 7, wherein:
the display unit can display a plurality of windows on a single monitor; and
the displaying step includes displaying reference/edition screens corresponding to a plurality of pieces of information in different ones of the windows respectively when the plurality of pieces of information are selected by the selection unit.

10. The inspection information administering method according to claim 7, wherein:
the selection unit is a launcher which can be always displayed on the display unit.

11. The inspection information administering method according to claim 7, further comprising:
when the plurality of pieces of information are selected by the selection unit, defining a piece of main information which is firstly selected from the plurality of pieces of information, and defining pieces of sub information each of which is selected subsequently to the piece of main information; and
allowing/prohibiting edit of each piece of sub information on the basis of a combination of the piece of main information and the piece of sub information.

12. The inspection information administering method according to claim 11, further comprising:
storing a definition file which defines prohibition combinations for prohibiting the edit of the pieces of sub information, from the combinations of the piece of main information and the respective pieces of sub information, wherein:
the allowing/prohibiting step includes allowing/prohibiting the edit of each piece of sub information with referring the definition file.

13. A computer readable medium storing a program causing a computer to execute a process for the inspection information administering method according to claim 7.
